(19) United States
(12) Patent Application Publication
(10) Pub. No.: US 2009/0242858 A1
(43) Pub. Date: Oct. 1, 2009

(54) Water-Based Fire Resistant Lubricant

(75) Inventors: Lorraine Palmerio, East Norriton, PA (US); Kevin Dickey, Belle Vernon, PA (US)

Correspondence Address: MORGAN, LEWIS & BOCKIUS LLP, 1701 MARKET STREET, PHILADELPHIA, PA, 19103-2921, US

(73) Assignee: QUAKER CHEMICAL CORPORATION, CONSHOHOCKEN, PA (US)

(21) Appl. No.: 12/085,237

(22) PCT Filed: Nov. 30, 2006
(86) PCT No.: PCT/US2006/045816

§ 371 Date: May 19, 2008

Related U.S. Application Data
(60) Provisional application No. 60/740,757, filed on Nov. 30, 2005.

(51) Int. Cl. C10M 133/04; C09K 21/10; C09K 21/12

(52) U.S. Cl. 252/602

(57) ABSTRACT

The present invention relates to a method for using a water-based fluid composition to lubricate metal-metal surfaces in contact with each other in a non-hydraulic system, wherein at least one of the metal surfaces is moving. The invention also relates to a water-based fluid composition for use as a lubricant in the described method.

### FIELD OF THE INVENTION

The present invention relates to a method for using a water-based fluid composition to lubricate metal-metal surfaces in contact with each other in a non-hydraulic system, wherein at least one of the metal surfaces is moving. The invention also relates to a water-based fluid composition for use as a lubricant in the described method.

### BACKGROUND OF THE INVENTION

Mineral oil based compositions are commonly used to lubricate machinery because these compositions offer reasonably effective lubrication at a low cost. Other manufacturers have switched to the more expensive ditridecyl adipate based compositions due to their superior lubrication. The drawback of both of these types of compositions is their flammability. In, for example, the glass bottle industry, these flammable compositions ignite when they come into contact with molten glass, the temperatures of which reach 2,400° F. As such, there is a risk of fires that can damage expensive machinery, resulting at the least in a loss of production and idle time for employees. Hence, there is a need for a fire-resistant lubricant. The lubricant of the present invention satisfies this need by being fire-resistant as well as having lubrication, pour point and even viscosity properties competitive with industry standards. Further, the lubricant of the invention is more environmentally friendly than oil based lubricants.

### SUMMARY OF THE INVENTION

An aspect of the invention relates to a method for lubricating metal-metal surfaces in contact with each other in a non-hydraulic system, wherein at least one of the metal surfaces is moving, comprising applying to the at least one of the metal surfaces a fire-resistant fluid composition comprising about 40 to about 95 percent by weight of water; about 0.1 to about 10 percent by weight of a secondary amide; and about 0.1 to about 10 percent by weight of a phosphorus-containing compound.

In another embodiment of the invention, the composition further comprises about 20 percent to about 60 percent by weight of a glycol.

In one embodiment, the composition further comprises a fatty acid, such as a dimerized fatty acid.

In one embodiment, the composition further comprises a trialkanolamine.

In one embodiment, the composition further comprises a water-soluble thickener.

### DETAILED DESCRIPTION OF THE INVENTION

In one embodiment, the present invention includes a method for lubricating a surface or surfaces by applying a composition of the present invention to the surface. In one embodiment, the surface having a composition of the invention applied thereto can be metal, ceramic, glass or a plastic surface. In another embodiment, a composition of the invention can be applied to a surface or surfaces in a non-hydraulic system. In certain embodiments, e.g., metal surfaces in a non-hydraulic system, wherein at least one surface is moving, the method includes applying to the moving surface a fire-resistant fluid composition of the invention.

As defined herein, a water/glycol hydraulic fluid containing a minimum water content of 35% is classified as type HFC.

In an embodiment of the invention, water is present in an amount of between about 70 to about 95 percent by weight. In another embodiment, water is present in an amount of between about 85 to about 95 percent by weight. In yet another embodiment, water is present in an amount of between about 90 to about 95 percent by weight.

In another embodiment of the invention, water is present in an amount of between about 40 to about 70 percent by weight and a glycol is present in an amount of about 20 percent to about 60 percent by weight. In another embodiment, water is present in an amount of between about 50 to about 65 percent by weight and a glycol is present in an amount of about 30 to about 50 percent by weight. In yet another embodiment, water is present in an amount of about 55 to about 60 percent by weight and a glycol is present about 35 to about 45 percent by weight.

Exemplary glycols for use in the composition include, but are not limited to, ethylene glycol; diethylene glycol; triethylene glycol; propylene glycol; 1,4-butylene glycol; thiodiethanol; 1,6-hexanediol; 3-methylpentane-1,5-diol; neopentyl glycol; 1,10-decanediol; 1,12-dodecanediol; cyclohexane dimethanol; benzene dimethanol; hydrogenated Bisphenol A; 2-butene-1,4-diol; and 3,9-bis (1,1-dimethyl-2-hydroxyethyl)-2,4,8,10-tetraoxaspiro[5.5]undecane. In one embodiment, at least one of propylene glycol and glycerol is used. In another embodiment, about 40% by weight of propylene glycol is present.

In one embodiment, the secondary amide is present in an amount of between about 0.1 to about 10 percent by weight. In another embodiment, the secondary amide is present in an amount of between about 0.5 to about 5 percent by weight. In another embodiment, the secondary amide is present in an amount of between about 1 to about 3 percent by weight. In one embodiment, the secondary amide is a dialkanolamide, such as, but not limited to, diethanolamide, dipropanolamide, diisopropanolamide and ethanolpropanolamide. In another embodiment, the dialkanolamid is a fatty acid dialkanolamide, such as a C₁₂₋₂₄-dialkanolamide, which is typically prepared from the reaction of dialkanolamine with selected fatty acids or fatty acid derivatives. In one embodiment, the C₁₂₋₂₄-dialkanolamide is a C₁₂₋₂₄-diethanolamide. In yet another embodiment, the C₁₂₋₂₄-fatty acid diethanolamide is a C₁₈-diethanolamide.

In one embodiment, the phosphorus-containing compound is a phosphoester. In another embodiment, the phosphoester is present in an amount of between about 0.5 to about 10 percent by weight. In another embodiment, the phosphoester is present in an amount of between about 1 to about 5 percent by weight. In yet another embodiment, the phosphoester is present in an amount of between about 1 to about 3 percent by weight.

In one embodiment, the composition further comprises a fatty acid, such as a dimerized fatty acid. In another embodiment, the dimerized fatty acid is present in an amount of between about 0.1 to about 5 percent by weight. In another embodiment, the dimerized fatty acid is present in an amount of between about 0.5 to about 3 percent by weight. In yet another embodiment, the dimerized fatty acid is present in an amount of between about 0.5 to about 2 percent by weight. In one embodiment, the dimerized fatty acid is a C₁₅₋₃₀-dimerized fatty acid. In another embodiment, the dimerized fatty acid is a C₂₁-dimerized fatty acid.

In one embodiment, the composition further comprises a trialkanolamine, such as, but not limited to, triethanolamine, tripropanolamine, trimethanolamine, diethanolpropanolamine, dimethylethanolamine, dimethylpropanolamine and tributanolamine. In another embodiment, the trialkanolamine is present in an amount of between about 0.05 to about 5 percent by weight. In another embodiment, the trialkanolamine is present in an amount of between about 0.1 to about 1 percent by weight. In yet another embodiment, the amount of the trialkanolamine is between about 0.1 to about 0.5 percent by weight. In one embodiment, the trialkanolamine is triethanolamine.

The water-based fluid of the invention may be thickened with a water soluble thickener to provide a composition with a viscosity similar to that of mineral oil. In contrast, the water based hydraulic fluids typically used in industry are not thickened. In one embodiment, the thickener is present in an amount of between about 0.05 to about 10 weight percent. In another embodiment, the thickener is present in an amount of between about 0.1 to about 5 weight percent. In yet another embodiment, the thickener is present in an amount of between about 0.1 and about 2 weight percent. In one embodiment, the thickener is a xanthan gum.

In one embodiment of the invention, the composition further comprises additives that include, but are not limited to, rust or corrosion inhibitors, emulsifying agents, antioxidants or oxidation inhibitors, dyes, detergents, defoamers, dispersants, viscosity index improvement agents, biocides and biostatic agents.

In one embodiment, the composition is used neat, i.e., without dilution.

In one embodiment, the pour point of the water based fluid compositions of the invention range from about −60 to about +10° C. In another embodiment, the pour point ranges from about −50 to about +5° C. In one embodiment where no glycol is present in the compostion, the pour point is about 0° C., while in another embodiment where glycol is present, the pour point is about −29° C.

Viscosity of the water based fluid compositions of the invention can be controlled by the addition of various thickeners. In one embodiment, the viscosity of the water based fluid compositions of the invention ranges from about 20 to about 250 cSt. at 0° C. In another embodiment, the viscosity ranges from about 40 to about 50 cSt.

The pH of the water based fluid compositions of the invention can be controlled by the addition of acid or base as needed. In one embodiment, the pH ranges from about 5 to about 11. In another embodiment, the pH ranges from about 7 to about 10.

In one embodiment, the non-hydraulic system is a glass manufacturing system. In another embodiment, the lubricant is used for open gear operations.

The water-based fluid of the invention is typically used neat. In contrast, most water-based hydraulic fluids used in industry are diluted, generally, from about 1 to about 5 percent. Further, even when the fluid of the invention is winterized (i.e., containing a glycol such as propylene glycol and/or glycerol to lower the pour point), there is still more water present than in a typical water glycol HFC type hydraulic fluid. The water glycol type hydraulic fluids generally used in industry were found to possess unsatisfactory fire resistance properties.

### EXAMPLES

### Example 1

### Quinotolubric Q-Glass-SG (Q807-C-Mod 1)

A specific composition that is indicative of the water-soluble compositions of the invention is shown in Table 1 below:

TABLE 1
Quintolubric Q-Glass-SG (Q807-C-Mod 1)

| Ingredient | % |
|---|---|
| Water | 24.00 |
| I-14142 | 0.20 |
| I-5510 | 3.00 |
| Triethanolamine 99% | 0.50 |
| Triazine | 0.50 |
| Water | 68.2 |
| Unmodified xanthan gum | 0.50 |
| Organosiloxane copolymer | 0.10 |
| Phos ester 18P | 2.00 |
| Difatac-C21 | 1.00 |

### Example 2

### Quintolubric Q-Glass-SG-W (Q807-C-Mod 2)

A “winterized” version of the composition of Example 1 that contains approximately 40% propylene glycol to provide a product with a low pour point during the winter months for use with plants in cold regions.

### Example 3

### Lubrication Studies

While lubrication tests were in progress, samples of Quintolubric 807-CS and Quintolubric 702-ISG underwent fire testing. Quintolubric 807-CS, which contains 68.46% water, performed very well in the fire test. Quintolubric 702-ISG, which contains about 40% water, failed the fire test, but it did perform better than TexGlass MV. Quintolubric 807-C is a thickened high water based product that would meet viscosity requirements and would also have good fire resistance because of the amount of water in the formulation (96.95%). However, the product would likely not provide the level of lubrication required. Two modifications of Quintolubric 807-C were prepared with increased levels of EP lubricants. One of the modifications also contained 40% propylene glycol to meet the pour point requirement. The formulations are shown in Table 2.

TABLE 2
Quintolubric 807-C Modifications

| Ingredient | Mod 1 | Mod 2 |
|---|---|---|
| Water | 24.0 | 12.0 |
| I-14142 | 0.20 | 0.12 |
| I-5510 | 3.0 | 1.8 |
| Triethanolamine (99%) | 0.50 | 0.30 |
| Triazine | 0.50 | 0.30 |
| Phos Ester 18P | 2.0 | 1.2 |
| Difatac C-21 | 1.0 | 0.60 |
| Water | 68.2 | 43.24 |
| Unmod Xanthan Gum | 0.50 | 0.30 |
| Organosiloxane | 0.10 | 0.06 |
| copolymer | | |
| Propylene glycol | — | 40.0 |

### Example 4

### Physical Properties

The physical properties for the experimental fluids and standard Quintolubric 807-C were determined and are depicted in Table 3.

TABLE 3
Physical Properties of Q807-C and Modifications

| | | Mod 1 | Mod 2 |
|---|---|---|---|
| | | (Quintolubric | (Quintolubric |
| Property | Q807-C | Q-Glass-SG) | Q-Glass-SG-W) |
| Appearance | Opaque | Opaque | Opaque |
| | Synovial Fluid | Synovial Fluid | Synovial Fluid |
| Brookfield | 710 cps | 420 cps | 360 cps |
| viscosity @ 72° F | | | |
| Neat pH | 9.5 | 8.5 | 8.6 |
| Pour Point | 32° F. (0° C.) | 32° F. (0° C.) | −20° F. (−29° C.) |

### Example 5

### Test Results

The two modifications of Quintolubric 807-C as depicted in Table 3 were tested. The winterized version of the product, Quintolubric Q-GLASS-SG-W (Mod 2 containing about 40% propylene glycol) was selected because of the location of the trial, where temperatures in the winter routinely go down to −20° F. The fluid was applied to two different pieces of equipment: the Lincoln Lube System and the Constant Cushion System. The equipment was disassembled eight months later and checked for wear. The wear results are shown in Table 4.

TABLE 4
Q-Glass Trial - Wear Results

| | | | Measured |
|---|---|---|---|
| | Drawing Dimension | | Dimension |
| | INVERT | | |
| Upper Bushing | 1.500 | | 1.5015 |
| 191-23022 | +0.001 | | |
| | | −.000 | |
| Cylinder | 4.000 | | 4.0010 |
| 191-2225 | +0.001 | | |
| | | −.002 | |
| Shaft | 1.497 | | 1.4970 |
| 191-8247-GO2 | +.000 | | |
| | | −.002 | |
| | UPPER BLOWHEAD | | |
| Bushing | 1.750 | | 1.7550 |
| 23-6527 | +.0015 | | |
| | | −.000 | |
| Bushing | 1.750 | | 1.7540 |
| 23-6535 | +.0015 | | |
| | | −.000 | |
| Bushing | 1.750 | | 1.7536 |
| 23-6536 | +.0015 | | |
| | | −.000 | |
| Bushing | 1.750 | | 1.7509 |
| 23-6534 | +.0015 | | |
| | | −.000 | |
| Bushing | 1.750 | | 1.7510 |
| 23-6534 | +.0015 | | |
| | | −.000 | |
| Piston & Shaft | 1.749 | | 1.7485 |
| 23-1114-G01 head | +.000 | | |
| | | −.002 | |
| Piston & Shaft | 1.750 | | 1.7490 |
| 23-1114-G01 cam | +.0015 | | |
| | | −.000 | |
| Cylinder | 4.496 | | 4.4975 |
| 23-6515 | +.002 | | |
| | | −.000 | |
| | NECK RING | | |
| | CYLINDER | | |
| Left Bearing | | N.A. | Oval |
| | | | 2.4966-2.4973 |
| Right Bearing | | N.A. | Oval |
| | | | 2.4966-2.4973 |

N.A. = not available

The data in Table 4 shows no measurable wear when using Quintolubric Q-Glass-SG-W as the fluid composition lubricant.

### Example 6

### Adjustment of Pour Point

The effect of varying the amounts of propylene glycol and glycerol present in a particular water based fluid composition (Quintolubric 814-01) on the composition's pour point was investigated. The solubility and pour points of samples of Quintolubric 814-01 were determined with various levels of glycerol and propylene glycol. The results shown in Table 3 show that propylene glycol is not soluble in Quintolubric 814-01 at concentrations >10%. Samples containing glycerol were hazy at concentrations >20%. The samples containing high concentrations of glycerol gelled at low temperatures making it unacceptable as a pour point depressant. From these results, Quintolubric 814-01 would need to be modified to be clear and stable with enough propylene glycol to achieve the pour point requirement.

TABLE 5
Pour Point Determinations for Q814-01

| Concentration | Propylene Glycol | Glycerol |
|---|---|---|
| 10% | 5° F. (−15° C.) | 5° F. (−15° C.) |
| 20% | Insoluble | −9° F. (−23° C.) |
| 30% | Insoluble | −20° F. (−29° C.) |
| 40% | Insoluble | −9° F. (−29° C.) cloudy |

### Example 7

### Adjustjment of Lubrication Properties

Modifications of Quintolubric 814-01 were prepared in order to formulate a product that was clear and stable with up to about 40% propylene glycol. Thirty-four (34) modifications were made before a stable product was obtained. Testing indicated that the level of Paraoil had to be reduced from about 6% to about 3% and the level of sodium sulfonate was increased to about 6% (Formula W). This formula contained 25% propylene glycol and resulted in a pour point of −15° F. (−26° C.).

Water-based lubricants inherently do not have the same lubrication properties as oil-based lubricants. For at least this reason, water-soluble extreme pressure (EP) lubricants were selected to help improve Quintolubric 814-01's lubrication properties. The lubricants selected are as follows: an amine phosest; a C21-diacid; a 18P; a polyether phosphate; and a fatty acid. Compounds such as these can help with boundary lubrication. From this formulation, four more formulations were prepared. Each modification contained one of the EP lubricants. The formulations are shown in Table 3.

TABLE 6
Formulation W and Its Modifications

| Ingredient | W | W1 | W2 | W3 | W4 |
|---|---|---|---|---|---|
| Water | 35.0 | 33.0 | 34.0 | 33.0 | 33.0 |
| Shela EDTA | 10.0 | 10.0 | 10.0 | 10.0 | 10.0 |
| V100 | | | | | |
| I-14142 | 0.5 | 0.5 | 0.5 | 0.5 | 0.5 |
| Diethanolamine | 3.0 | 3.0 | 3.0 | 3.0 | 3.0 |
| Monomethyl | 2.5 | 2.5 | 2.5 | 2.5 | 2.5 |
| DPG Ether | | | | | |
| I-5510 | 11.0 | 11.0 | 11.0 | 11.0 | 11.0 |
| Tallowac 7920 | 1.0 | 1.0 | 1.0 | 1.0 | 1.0 |
| Oleic Acid 70 | 2.5 | 2.5 | 2.5 | 2.5 | 2.5 |
| Sod | 6.0 | 6.0 | 6.0 | 6.0 | 6.0 |
| C15-30 Alkaryl | | | | | |
| Sulfone | | | | | |
| Paraoil 230 | 3.0 | 3.0 | 3.0 | 3.0 | 3.0 |
| Propylene | 25.0 | 25.0 | 25.0 | 25.0 | 25.0 |
| Glycol | | | | | |
| Bioaze G | 0.5 | 0.5 | 0.5 | 0.5 | 0.5 |
| Amine Phosest | — | 2.0 | — | — | — |
| C21 Diacid | — | — | 1.0 | — | — |
| 18P | — | — | — | 2.0 | — |
| Polyether | — | — | — | — | 2.0 |
| Phosphate | | | | | |

### Example 8

### Formula Modifications

Additionally, formula modifications of Quintolubric 807-CS and Quintolubric 702-ISG were prepared with each of the EP lubricants. Quintolubric 702-ISG is a water glycol (HFC). Forty percent (40%) propylene glycol was added to the Quintolubric 807-CS modifications. The formulations are shown in Tables 4 and 5.

TABLE 7
Quintolubric 807-CS Formula Modifications

| Ingredient | 807 | 807-A | 807-B | 807-C | 807-D |
|---|---|---|---|---|---|
| Q807-CS | 60.0 | 58.0 | 59.0 | 58.0 | 58.0 |
| Propylene | 40.0 | 40.0 | 40.0 | 40.0 | 40.0 |
| Glycol | | | | | |
| Amine | — | 2.0 | — | — | — |
| Phosest | | | | | |
| C21 Diacid | — | — | 1.0 | — | — |
| 18P | — | — | — | 2.0 | — |
| Polyether | — | — | — | — | 2.0 |
| Phosphate | | | | | |

TABLE 8
Quintolubric 702-ISG Formula Modifications

| Ingredient | 702 | 702-A | 702-B | 702-C | 702-D |
|---|---|---|---|---|---|
| Q702-ISG | 60.0 | 58.0 | 59.0 | 58.0 | 58.0 |
| Propylene | 40.0 | 40.0 | 40.0 | 40.0 | 40.0 |
| Glycol | | | | | |
| Amine | — | 2.0 | — | — | — |
| Phosest | | | | | |
| C21 Diacid | — | — | 1.0 | — | — |
| 18P | — | — | — | 2.0 | — |
| Polyether | — | — | — | — | 2.0 |
| Phosphate | | | | | |

### Example 9

### Pour Points and Viscosities

Pour points and viscosities were determined for each modification and are shown in Table 9.

TABLE 9
Pour Points and Viscosities

| | | Pour | Viscosity | Viscosity |
|---|---|---|---|---|
| Product | Appearance | Point (° C.) | @ 40° C. | @ 0° C. |
| TexGlass MV | Clear Amber | −29 | 114 cSt | 1525 cSt |
| W | Clear Yellow | −26 | 13.9 cSt | 116.8 cSt |
| W1 | Cloudy, | — | — | — |
| | Unstable | | | |
| W2 | Cloudy, | — | — | — |
| | Unstable | | | |
| W3 | Clear Yellow | −15 | 20.9 cSt | 213.7 sCt |
| W4 | Cloudy, | — | — | — |
| | Unstable | | | |
| 807 w/40% | Clear and | −30 | 4.68 cSt | 28.9 cSt |
| propylene glycol | Stable | | | |
| 807A | Clear and | −28 | 6.55 cSt | 46.4 cSt |
| | Stable | | | |
| 807B | Clear and | −30 | 6.23 cSt | 41.5 cSt |
| | Stable | | | |
| 807C | Clear and | −28 | 7.15 cSt | 49.0 cSt |
| | Stable | | | |
| 807D | Clear and | −30 | 6.58 cSt | 45.5 cSt |
| | Stable | | | |
| 702 | Clear Red | −40 | 46.0 cSt | — |
| 702A | Hazy | — | — | — |
| 702B | Clear and | <−30 | 47.0 cSt | — |
| | Stable | | | |
| 702C | Clear and | <−30 | 46.5 cSt | — |
| | Stable | | | |
| 702D | Clear and | <−30 | 47.2 cSt | — |
| | Stable | | | |

From Table 9 above, it can be seen that numerous formulations were prepared that met the criteria for pour point. These formulations would then be evaluated for their lubrication properties. Previous work with the Four-Ball Wear Test showed that it was not a good indicator of how the product would perform in the glass making equipment. Therefore, another test was run where a test ring, with various loads, rotated on a flat metal washer. The speed was determined to be approximately 50 rpm. In this test, an industry standard lubricant, TexGlass MV, performed very well while Quintolubric 822-300-CM did not. From the description provided, the Falex block on ring appeared to be the best test equipment to evaluate the lubrication properties of the experimental products.

### Example 10

### Friction and Wear

ASTM D2714: Calibration and Operation of the Falex Block-on-Ring Friction and Wear Testing Machine was used. In this test, a steel test ring is rotated against a steel test block at a rate of 72 rpm. The specimen assembly is partially immersed in the test fluid. The specimens were subjected to a 150-lb. normal load, at 110° F. for 5,000 cycles. Upon completion of the test, 3 determinations are made: (1) the friction force after a certain number of cycles, (2) the average width of the wear scar on the stationary block at the end of the test, and (3) the weight loss for the stationary block at the end of the test. All of the formulated fluids as well as TexGlass MV, Quintolubric 822-300-CM, Quintolubric 814-01, Quintolubric 807-CS, and Quintolubric 702-ISG were evaluated in the Falex Block-on-Ring Test. The results are shown in Table 7.

TABLE 10
ASTM D2714 - Falex Block-on-Ring Test Results

| | Friction | Friction | Friction | Friction | | | Block |
|---|---|---|---|---|---|---|---|
| | Force | Force | Force | Force | Scar | | Weight |
| Fluid | of 200 | of 400 | of 600 | of 4500 | Diameter | | Loss |
| TexGlass | 15.4 | 14.5 | 13.9 | 13.6 | 0.70 | mm | 0.3 mg |
| MV | | | | | | | |
| Q822-300- | 18.5 | 17.4 | 16.2 | 13.9 | 1.0 | mm | 0.4 mg |
| CM | | | | | | | |
| Q814-01 | 21.0 | 20.1 | 19.2 | 19.6 | 1.3 | mm | 1.4 mg |
| Q807-CS | 26.7 | 24.8 | 22.8 | 16.5 | 1.5 | mm | 0.5 mg |
| Q702-ISG | 22.1 | 18.4 | 16.0 | 13.0 | 1.4 | mm | 0.1 mg |
| MOD. W | 23.9 | 20.8 | 18.9 | 17.5 | 1.5 | mm | 1.6 mg |
| W1 | — | — | — | — | — | | — |
| W2 | — | — | — | — | — | | — |
| W3 | 23.6 | 22.4 | 20.1 | 18.0 | 1.5 | mm | 1.0 mg |
| W4 | — | — | — | — | — | | — |
| 807-A | 21.6 | 20.7 | 19.4 | 15.7 | 1.2 | mm | 0.9 mg |
| 807-B | 24.4 | 23.6 | 21.4 | 18.2 | 1.9 | mm | 3.0 mg |
| 807-C | 22.6 | 18.4 | 16.8 | 15.7 | 1.35 | mm | 1.7 mg |
| 807-D | 26.7 | 23.0 | 20.4 | 15.9 | 1.75 | mm | 1.7 mg |
| 702-A | — | — | — | — | — | | — |
| 702-B | 24.1 | 20.9 | 16.1 | 11.6 | 1.5 | mm | 0.6 mg |
| 702-C | 18.7 | 16.0 | 13.6 | 11.0 | 1.2 | mm | 1.0 mg |
| 702-D | 18.9 | 16.5 | 15.4 | 9.9 | 1.15 | mm | 0.7 mg |

Results show that TexGlass MV has the smallest scar diameter and block weight loss. Quintolubric 822-300-CM has slightly worse results, but is not equivalent to TexGlass MV. Any new product developed must have a scar diameter of <1.0 mm and a block weight loss of about 0.3 mg. None of the experimental products were equivalent to TexGlass MV with regard to scar diameter or block weight loss. With regard to friction force, TexGlass MV had a lower initial friction force (at 200 cycles), but several of the experimental products had lower friction force values after 4500 cycles. It may be that the initial friction force is more indicative of performance than final friction force since the fluids with lower friction force values at 4500 cycles showed larger scar diameters and higher block weight loss values.

### Example 11

### Coefficient of Friction Values

The coefficient of friction (COF) values can be calculated from the friction force values as follows:
f=F/W where: f=coefficient of friction;
F=measured friction force, kg (lb); and
W=normal load, kg (lb)

Coefficient of friction values were calculated for each product and are listed in Table 11.

TABLE 11
Coefficient of Friction Values

| | Coefficient | Coefficient | Coefficient | Coefficient |
|---|---|---|---|---|
| | of Friction | of Friction | of Friction | of Friction |
| Fluid | 200 | 400 | 600 | 4500 |
| TexGlass MV | 0.103 | 0.097 | 0.093 | 0.091 |
| Q822-300-CM | 0.123 | 0.116 | 0.108 | 0.093 |
| Q814-01 | 0.140 | 0.134 | 0.128 | 0.131 |
| Q807-CS | 0.178 | 0.165 | 0.152 | 0.110 |
| Q702-ISG | 0.147 | 0.123 | 0.107 | 0.087 |
| MOD. W | 0.159 | 0.139 | 0.126 | 0.117 |
| W1 | — | — | — | — |
| W2 | — | — | — | — |
| W3 | 0.157 | 0.149 | 0.134 | 0.120 |
| W4 | — | — | — | — |
| 807-A | 0.144 | 0.138 | 0.129 | 0.105 |
| 807-B | 0.163 | 0.157 | 0.143 | 0.121 |
| 807-C | 0.151 | 0.123 | 0.112 | 0.105 |
| 807-D | 0.178 | 0.153 | 0.136 | 0.106 |
| 702-A | — | — | — | — |
| 702-B | 0.161 | 0.139 | 0.107 | 0.077 |
| 702-C | 0.125 | 0.107 | 0.091 | 0.073 |
| 702-D | 0.126 | 0.110 | 0.103 | 0.066 |

### Example 12

### Friction and Wear Studies

Four-Ball Wear Tests were also performed on the fluids to determine if there was any correlation between the two tests. Results, shown in Table 12, indicate that the scar diameters obtained with the 40-kg load correlate with the scar diameters obtained on the stationery block in the Falex Block-on-Ring Test. TexGlass MV was superior to the other fluids tested with a scar diameter of 0.42 mm. Quintolubric 822-300-CM was slightly worse than TexGlass MV and all of the water-based fluids were inferior with respect to lubrication under the conditions tested.

TABLE 12
ASTM D4172 - Four-Ball Wear Test Results

| Sample | 15 KG | 40 KG |
|---|---|---|
| TexGlass MV | 0.23 mm | 0.42 mm |
| Q822-300-CM | 0.20 mm | 0.53 mm |
| Q814-01 | 0.90 mm | 0.90 mm |
| Q807-CS | 0.57 mm | 0.73 mm |
| Q702-ISG | 0.57 mm | 0.67 mm |
| Mod. W | 0.80 mm | 0.83 mm |
| W3 | 0.68 mm | 1.08 mm |
| 807-A | 0.90 mm | 0.98 mm |
| 807B | 0.36 mm | 0.66 mm |
| 807C | 0.78 mm | 0.90 mm |
| 807D | 0.77 mm | 1.0 mm |
| 702B | 0.43 mm | 0.52 mm |
| 702C | 0.62 mm | 0.63 mm |
| 702D | 0.72 mm | 0.78 mm |
| 807-CS w/40% | 0.41 mm | 0.71 mm |
| propylene glycol | | |

The foregoing detailed description has been given for clearness of understanding only and no unnecessary limitations should be understood therefrom as modifications will be obvious to those skilled in the art. While the invention has been described in connection with specific embodiments thereof, it will be understood that the invention is capable of further modifications. This application is intended to cover any variations, uses, or adaptations of the invention following, in general, the principles of the invention and including such departures from the present disclosure as come within known or customary practice within the art to which the invention pertains and as may be applied to the essential features herein before set forth and as follows in the scope of the appended claims.

1. A method for lubricating metal-metal surfaces in contact with each other in a non-hydraulic system, wherein at least one of the metal surfaces is moving, comprising:
applying to the at least one of the metal surfaces a fire-resistant fluid composition comprising
about 40 to about 95 percent by weight of water; and
a secondary amide.

2. The method according to claim 2, wherein the secondary amide is present in an amount of between from about 0.1 to about 10 percent by weight.

3. The method according to claim 2, wherein the secondary amide is present in an amount of between from about 0.5 to about 5 percent by weight.

4. The method according to claim 1, wherein the secondary amide is a dialkanolamide.

5. The method according to claim 4, wherein the dialkanolamide is diethanolamide.

6. The method according to claim 5, wherein the diethanolamide is a C₁₂₋₂₄-diethanolamide.

7. The method according to claim 6, wherein the diethanolamide is a C₁₈-diethanolamide.

8. The method according to claim 1, wherein the composition further comprises a fatty acid.

9. The method according to claim 8, wherein the fatty acid is a dimerized fatty acid.

10. The method according to claim 9, wherein the dimerized fatty acid is a C₁₅₋₃₀-dimerized fatty acid.

11. The method according to claim 10, wherein the dimerized fatty acid is a C₂₁-dimerized fatty acid.

12. The method according to claim 1, wherein the composition further comprises a trialkanolamine.

13. The method according to claim 12, wherein the trialkanolamine is triethanolamine.

14. The method according to claim 1, wherein the composition further comprises a phosphoester.

15. The method according to claim 14, wherein the phosphoester is present in an amount of between from about 0.5 to about 10 percent by weight.

16. The method according to claim 1, wherein the composition further comprises a water-soluble thickener.

17. The method according to claim 16, wherein the water-soluble thickener is a xanthan gum.

18. The method according to claim 1, wherein the water is present in an amount of between from about 70 to about 95 percent by weight.

19. The method according to claim 1, wherein the water is present in an amount of between from about 40 to about 70 percent by weight and the composition further comprises a glycol.

20. The method according to claim 19, wherein the water is present in an amount of between from about 50 to about 65 percent by weight and the glycol is present in an amount of between from about 20 to about 60 percent by weight.

21. The method according to claim 20, wherein the glycol is propylene glycol.

22. The method according to claim 21, wherein the propylene glycol is present in an amount of between about 35 and about 45 percent by weight.

23. The method according to claim 1, wherein the fluid composition is not further diluted.

24. The method according to claim 1, wherein the non-hydraulic system is a glass manufacturing system.

25. A fluid composition for lubricating metal-metal surfaces in contact with each other in a non-hydraulic system, wherein at least one of the metal surfaces is moving, comprising:
about 40 to about 95 percent by weight of water; and
a secondary amide.

26. The composition according to claim 25, wherein the secondary amide is present in an amount of between from about 0.1 to about 10 percent by weight.

27. The composition according to claim 26, wherein the secondary amide is present in an amount of between from about 0.5 to about 5 percent by weight.

28. The composition according to claim 25, wherein the secondary amide is a dialkanolamide.

29. The composition according to claim 28, wherein the dialkanolamide is diethanolamide.

30. The composition according to claim 29, wherein the diethanolamide is a C₁₂₋₂₄-diethanolamide.

31. The composition according to claim 30, wherein the diethanolamide is a C₁₈-diethanolamide.

32. The composition according to claim 25, further comprising a fatty acid.

33. The composition according to claim 32, wherein the fatty acid is a dimerized fatty acid.

34. The composition according to claim 33, wherein the dimerized fatty acid is a C₁₅₋₃₀-dimerized fatty acid.

35. The composition according to claim 34, wherein the dimerized fatty acid is a C₂₁-dimerized fatty acid.

36. The composition according to claim 25, further comprising a trialkanolamine.

37. The composition according to claim 36, wherein the trialkanolamine is triethanolamine.

38. The composition according to claim 25, further comprising a phosphoester.

39. The composition according to claim 38, wherein the phosphoester is present in an amount of between from about 0.5 to about 10 percent by weight.

40. The composition according to claim 25, further comprising a water-soluble thickener.

41. The composition according to claim 40, wherein the water-soluble thickener is a xanthan gum.

42. The composition according to claim 25, wherein the water is present in an amount of between from about 70 to about 95 percent by weight.

43. The composition according to claim 25, wherein the water is present in an amount of between from about 40 to about 70 percent by weight and the composition further comprises a glycol.

44. The composition according to claim 43, wherein the water is present in an amount of between from about 50 to about 65 percent by weight and the glycol is present in an amount of between from about 20 to about 60 percent by weight.

45. The composition according to claim 44, wherein the glycol is propylene glycol.

46. The composition according to claim 45, wherein the propylene glycol is present in an amount of between about 35 and about 40 percent by weight.

47. The composition according to claim 25, wherein the fluid composition is not further diluted.

48. The composition according to claim 25, further comprising at least one additive selected from the group consisting of rust or corrosion inhibitors, emulsifying agents, antioxidants or oxidation inhibitors, dyes, detergents, dispersants, viscosity index improvement agents, biocides and biostatic agents.

49. The composition of claim 25, wherein the composition has a viscosity between about 20 to about 250 cSt. at 0° C.
